(19) United States
(12) Patent Application Publication
(10) Pub. No.: US 2009/0047106 A1
(43) Pub. Date: Feb. 19, 2009

(54) In-Ground Unloading for Side-dump Trailers

(76) Inventor: Lloyd Ash, Pleasant Grove, UT (US)

Correspondence Address: THORPE NORTH & WESTERN, LLP., P.O. Box 1219, SANDY, UT, 84091-1219, US

(21) Appl. No.: 12/190,472

(22) Filed: Aug. 12, 2008

Related U.S. Application Data
(60) Provisional application No. 60/965,030, filed on Aug. 14, 2007.

(51) Int. Cl. B65G 65/04; B65G 65/34

(52) U.S. Cl. 414/418; 414/809

(57) ABSTRACT

An unloading station disposable adjacent an aggregate material transport vehicle thoroughfare, and configured to rapidly receive and transfer the contents of a side-dump aggregate material transport vehicle includes a hopper disposed adjacent the transport vehicle thoroughfare. The hopper extends longitudinally alongside an aggregate material transport vehicle thoroughfare. The hopper has a front wall sized to receive aggregate material from a side-dump transport vehicle, and a rear wall sized to impede the flow of the aggregate material dumped over the front wall by the side-dump transport vehicle. A conveyor system is disposed under the hopper, and is operable to move aggregate material from the hopper to a remote location away from the unloading station.

### PRIORITY CLAIM

Benefit is claimed of U.S. Provisional Patent Application No. 60/965,030, filed Aug. 14, 2007, which is herein incorporated by reference in its entirety for all purposes.

### BACKGROUND OF THE INVENTION

1. Field of the Invention

The present invention relates generally to transportation and storage of aggregate material such as coal, ore, gravel, soil, and the like.

2. Related Art

Aggregate material is often moved overland by truck trailer or rail car. A wide variety of hopper type vehicles such as rapid discharge railcars, dump trucks, bottom discharge trailers, and the like have been developed to rapidly unload aggregate material from the transport vehicle.

Another type of vehicle gaining in popularity for moving aggregate material is a side-dump trailer. A side-dump trailer has a dump bed or hopper that tilts along a longitudinal axis of the trailer or vehicle body such that the hopper contents are dumped on the ground along the longitudinal side of the transport vehicle. Such side-dump vehicles are often used to transport valuable cargo such as mineral ores since there is reduced risk of losing the valuable ore from a bottom or rear opening in the hopper.

Reclaiming the material dumped from the side-dump trailer is often problematic. Generally, after the material is dumped, the material must be picked up and moved from the dump site by a front end loader, backhoe, or the like. Unfortunately, reclaiming mineral ore from the ground can add contamination and impurities to the material that must subsequently be cleaned or refined out of the ore. Additionally, reclamation involving an intermediate material mover, such as a front end loader, is not practical for moving the material to long haul transportation such as trains or ships because it dramatically increases the time and cost of shipping and handling of the material.

### SUMMARY OF THE INVENTION

The inventor of the present invention has recognized that it would be advantageous to develop an automated method and device for capturing or reclaiming aggregate material dumped from a side-dump trailer.

The invention provides for an unloading station disposable adjacent an aggregate material transport vehicle thoroughfare, and configured to rapidly receive and transfer the contents of a side-dump aggregate material transport vehicle. The unloading station can include a hopper disposed at least partially below a ground level. The hopper can extend longitudinally adjacent an aggregate material transport vehicle thoroughfare, such as a roadway or railway. The hopper can include a front retaining wall disposed adjacent the transport vehicle thoroughfare with an elevation sufficient to allow aggregate material to pass from a dump bed of the transport vehicle into the hopper when the dump bed is in a dump position. The hopper can also include a rear retaining wall disposed in a spaced apart relation to the short containment wall with an elevation sufficient to substantially impede movement of aggregate material dumped from the transport vehicle.

In another aspect, the unloading station can also include a material containment space disposed between the front retaining wall and the rear retaining wall. The material containment space can be sized and shaped to substantially contain aggregate material dumped from the transport vehicle.

In another more detailed aspect, the unloading station can also include a conveyor system disposed under the material containment space, and operable to receive and move aggregate material from the material containment space.

The present invention also provides for a method for unloading a side-dump aggregate material transport vehicle including positioning a side-dump aggregate material transport vehicle on a thoroughfare adjacent a side-dump unloading station. A dump bed of the aggregate material transport vehicle can be tipped along a longitudinal axis of the vehicle in order to dump aggregate material contents of the dump bed along a side of the transport vehicle and into a hopper of the unloading station. A conveyor system disposed under the hopper of the unloading station can be activated to convey aggregate material away from the hopper of the unloading station.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of an aggregate material unloading station for receiving and reclaiming aggregate material from a side-dump aggregate material transport vehicle;

FIG. 2 is a rear view of the unloading station of FIG. 1, shown with a side-dump aggregate material transport vehicle positioned adjacent the unloading station with a hopper of the transport vehicle in an un-tipped or transport ready position;

FIG. 3 is a rear view of the unloading station of FIG. 1, shown with the side-dump aggregate material transport vehicle shown in FIG. 2 positioned adjacent the unloading station and with the hopper of the transport vehicle in an tipped, unloading, or dumped position;

FIG. 4 is a front view of the unloading station of FIG. 1;

FIG. 5 is a front view of a hopper and material transfer space of the unloading station of FIG. 1;

FIG. 6 is a side view of the unloading station of FIG. 1;

FIG. 7 is an fragmentary side view of the unloading station of FIG. 1, showing a lateral conveyor belt;

FIG. 8 is a side view of the unloading station of FIG. 1;

FIG. 9 is a top view of the unloading station of FIG. 1;

FIG. 10 is a front view of the unloading station of FIG. 1, shown with a transport vehicle vibrator extending above a hopper;

FIG. 11 is a side view of the unloading station of FIG. 1, with a plurality of jacks in an un-raised position;

FIG. 12 is a front view of the unloading station of FIG. 1, with a plurality of jacks in an un-raised position;

FIG. 13 is a side view of the unloading station of FIG. 1, with a plurality of jacks in an raised position; and

FIG. 14 is a front view of the unloading station of FIG. 1, with a plurality of jacks in a raised position.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for an automated an unloading station that can be positioned longitudinally alongside or adjacent to an aggregate material transport vehicle thoroughfare, such as a roadway or railroad track. The unloading station can include a hopper with a longitudinal length approximately equal to the longitudinal length of a side-dump trailer so that the side dump trailer can dump aggregate material directly into the unloading station which can receive and then rapidly transfer the material to a remote location away from the unloading station. The hopper can include a pair of walls having different heights to facilitate receipt and containment of the aggregate material. For example, the hopper can have a shorter front wall positioned alongside the thoroughfare and a taller rear wall farther away from the thoroughfare. The shorter wall allows material from the dump bed of the trailer to pass over the wall and into the space between the front and back wall. The taller rear wall can be sufficiently tall to substantially impede the movement of the aggregate material as it falls from the dump bed and over the front wall. The space between the front and rear walls of the hopper can define a material containment space that can be sized and shaped to substantially contain the entire aggregate material load of the transport vehicle. A conveyor system can be disposed below the hopper to move the aggregate material away from the unloading station.

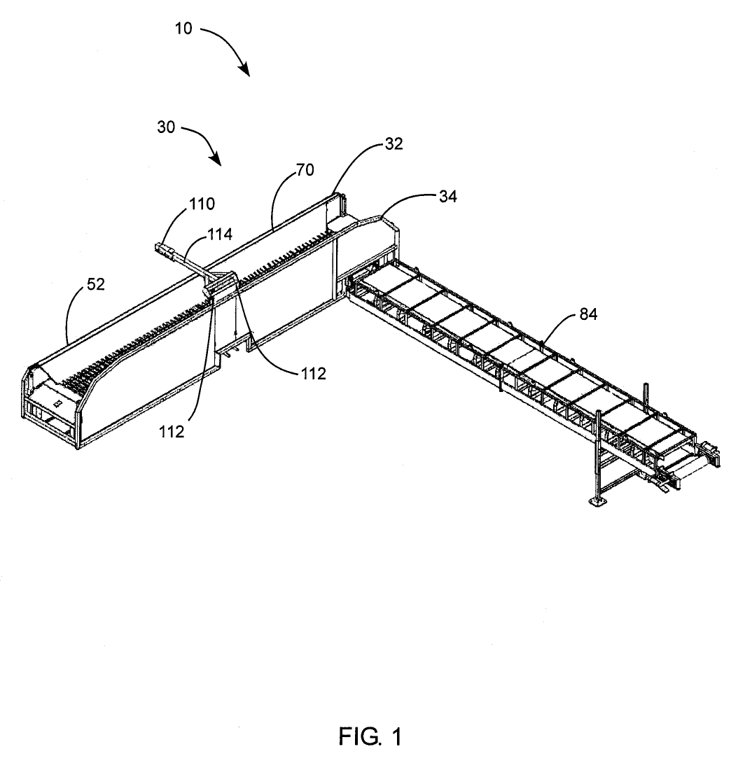

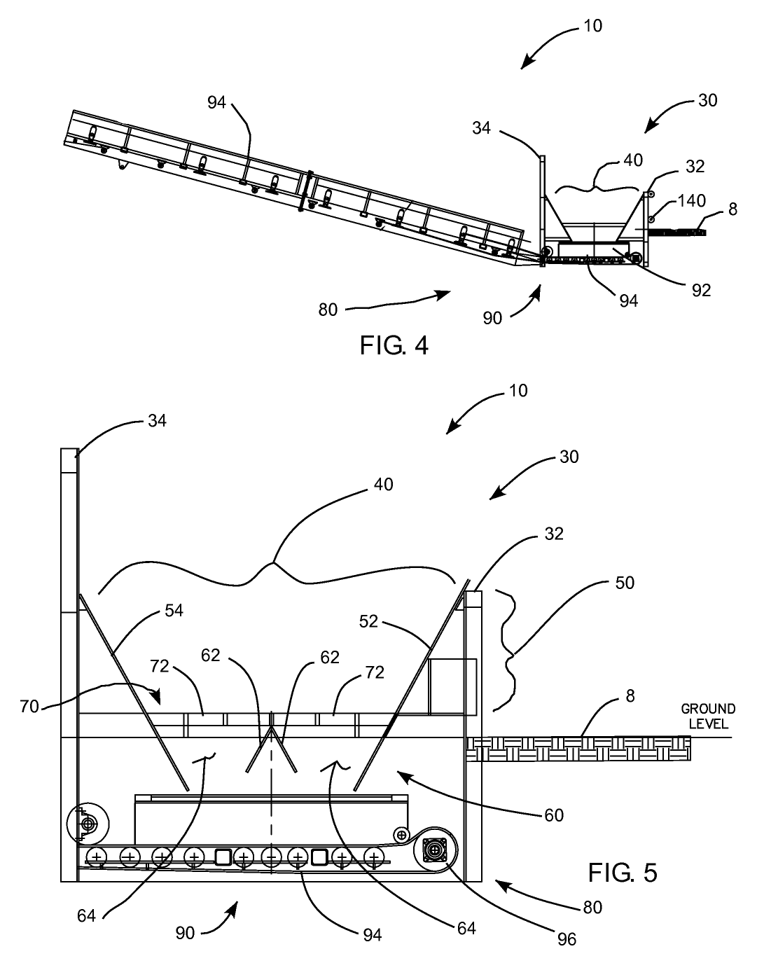

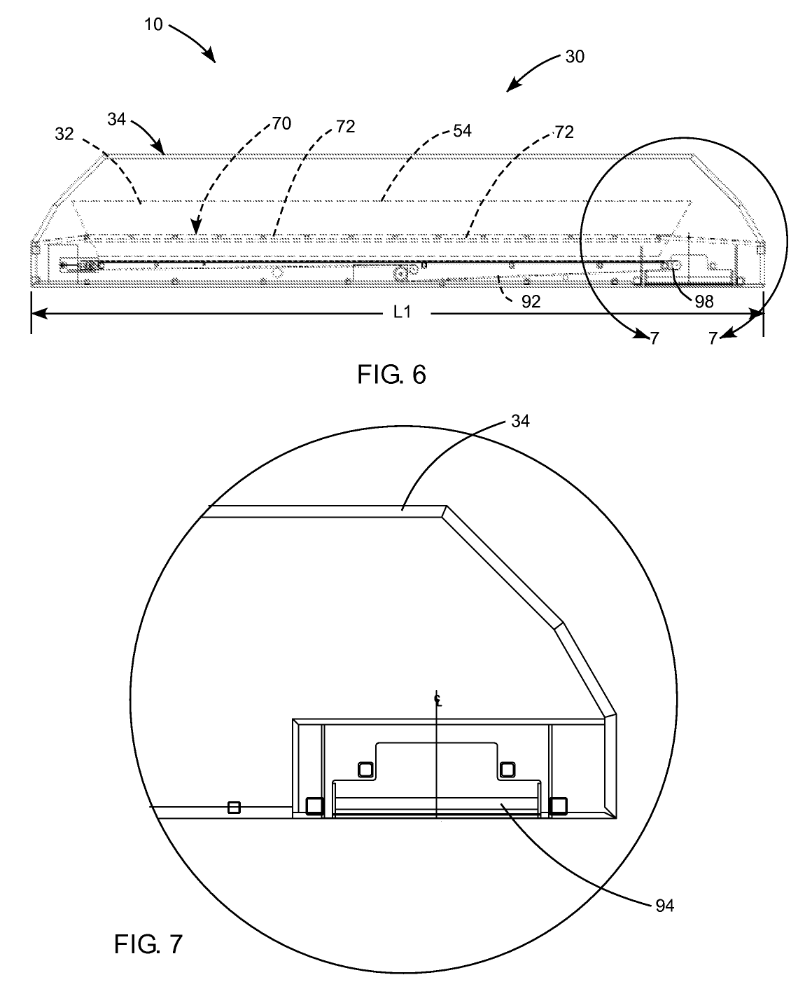

As illustrated in FIGS. 1-14, an aggregate material unloading station, indicated generally at 10, in accordance with the present invention is shown for use unloading, recovering, and/or reclaiming aggregate material from a side-dump aggregate material transport vehicle such as a truck, trailer 12, railcar, and the like. The unloading station 10 can include a hopper, indicated generally at 30, and a conveyor system, indicated generally at 80. The unloading station 10 described herein can be similar in many respect to the bulk material unloading apparatus described in U.S. patent application Ser. No. 11/809,731 filed on Jun. 1, 2007 which is herein incorporated by reference in its entirety for all purposes.

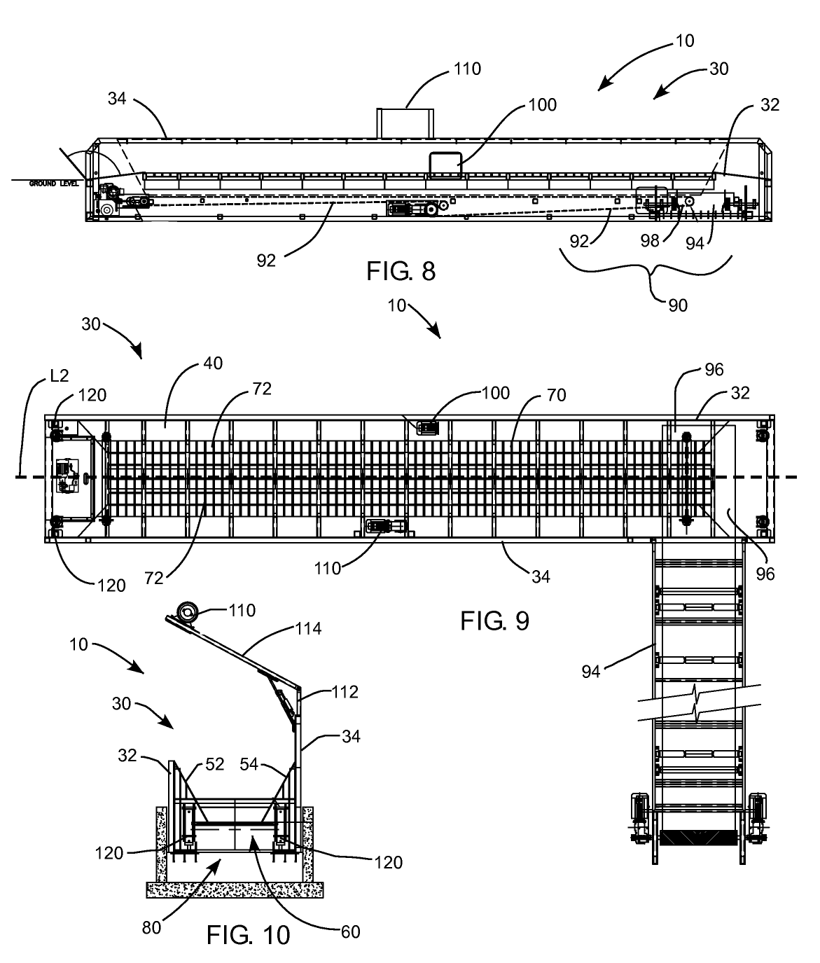

The hopper 30 can be disposed longitudinally alongside or adjacent to a transport vehicle thoroughfare 8. The hopper 30 can have a longitudinal length, L1 (FIG. 8), substantially corresponding to a longitudinal length (not shown) of the aggregate material transport vehicle 12 or dump bed 14 thereof so that when the transport vehicle dumps the aggregate material, the hopper 30 can receive and contain substantially the entire load from end to end. In one aspect, the longitudinal length L1 can be approximately 30, 40 or even 50 feet long. Additionally, more than one hopper 30 and conveyor system 80 can be placed end to end along the thoroughfare 8 to create an even longer unloading station if desired.

The hopper 30 can also have a front retaining wall 32 disposed along side or adjacent to the transport vehicle thoroughfare 8 and a rear retaining wall 34 disposed in a parallel spaced apart relation to the front retaining wall 32. The front and rear retaining walls 32 and 34 can be formed from steel plates coupled to a steel framework so as to provide sufficient strength to the walls to receive the aggregate material from the transport vehicle 12 without damage to the hopper 30.

The front retaining wall 32 can have a different height or elevation than the rear retaining wall 34. For example, the front retaining wall 32 can be relatively shorter than the rear retaining wall 34. The shorter front retaining wall 32 can be sufficiently short so as to allow the dump bed 14 of the transport vehicle 12 to be positioned over the front wall 32 when the dump bed 14 is in the tipped or dumped position during unloading of the aggregate material, as shown in FIG. 3. In one aspect, the front retaining wall 32 can be approximately 36 inches high and the rear retaining wall 34 can be approximately 72 inches high with respect to the ground surface 8. Advantageously, the shorter elevation of the front wall 32 facilitates aggregate material moving from the transport vehicle dump bed 14 to the unloading station hopper 30 and minimizes loss of material outside the retaining walls 32 and 34 of the hopper.

The hopper 30 can also have a material containment space, indicated generally at 40. The material containment space 40 can be disposed between the front and rear retaining walls 32 and 34. The material containment space 40 can be sized and shaped to substantially contain the entire aggregate material load dumped from the transport vehicle 12 into the hopper 30.

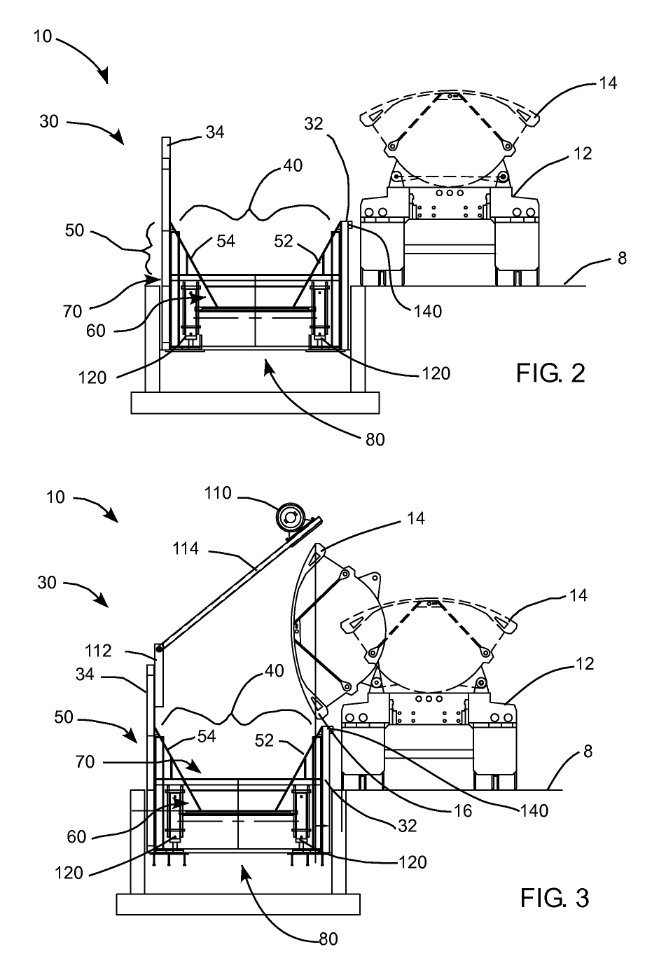

Advantageously, the hopper 30 can be disposed at least partially below a ground level to facilitate the tipping and dumping of the transport vehicle dump bed 14. It will be appreciated that side-dump transport vehicles, such as the trailer 12 shown in FIGS. 2 and 3, can have a relatively low discharge point 16 with respect to the ground surface 8. Consequently, positioning above-ground transfer equipment such as conveyor belts and the like adjacent a side-dump transport vehicle dump bed 14 can interfere with the tipping and dumping operation of the aggregate material.

Thus, advantageously, the hopper 30 of the present invention can be disposed in a shallow excavation so as to allow adequate dumping space for the aggregate material being dumped from the transport vehicle 12. In one aspect, the shallow excavation can be less than 48 inches deep. The excavation can also include a concrete footing 130 (FIGS. 12 and 14) sized and shaped to support the weight of the unloading station plus the weight of a load of aggregate material. Additionally, the excavation can be lined with a suitable lining 132 (FIGS. 12 and 14), such as concrete, to reduce collapse of the excavation walls.

It is a particular advantage of the unloading station 10 of the present invention that only shallow excavation is needed to accommodate the unloading station. It will be appreciated that large scale or deeper excavations can be costly, and take a significant amount of time and structure to build. Thus, the shallow excavation that can be used to house the unloading station 10 described herein reduces excavation and structure costs of traditional pit dumping stations that can have depths ranging from 20 to 50 feet.

The material containment space 40 of the hopper 30 can also include a material storage space, indicated generally at 50, disposed above ground level, and a material flow regulator, indicated generally at 60, disposed at least partially below the ground level. The material flow regulator 60 can be configured to contain and direct aggregate material dumped from the transport vehicle. For example, the material flow regulator 60 can include a pair of inclined vertical walls 52 and 54 extending along the containment walls 32 and 34, respectively. The inclined walls 52 and 54 can be inclined to direct aggregate material toward a center region of the material containment space 40. The inclined walls 52 and 54 can be fabricated from steel plates coupled to steel beams by coupling methods known in the art, such as fasteners, welding, or the like.

The material flow regulator 60 can be disposed at least partially below the ground level substantially under the material containment space 40. The material flow regulator 60 can be configured to regulate the flow of the bulk material moving out of the material containment space 40. For example, as shown in FIG. 5, the material flow regulator 60 can also include a plurality of baffles 62 disposed within the material flow regulator 60. The baffles 62 can extend transverse to a longitudinal axis, L2 (FIG. 9), of the hopper 30. The baffles 62 can form apertures 64 that are sized and shaped to allow horizontal material movement below the material regulator 60 while limiting or impeding horizontal material movement in the material containment space 40. By controlling both the flow and the horizontal movement of the aggregate material, the baffles 62 and inclined walls 52 and 54 of the material regulator 60 can limit the loading placed on the conveyor system. A baffle system such as describe herein is further explained in the inventors co-pending patent applications U.S. patent application Ser. No. 11/810,173 filed on Jun. 4, 2007 and U.S. patent application Ser. No. 11/809,731 filed Jun. 1, 2007 which are incorporated by reference herein for all purposes in their entirety.

The material flow regulator 60 can also include a sizing grid 70. The sizing grid 70 can be disposed in the hopper 30 substantially between the material storage space 50 and the material flow regulation space 60 at approximately ground level 8. The sizing grid 70 can include apertures 72 having a predetermined size in order to allow aggregate material having the predetermined size to flow through the sizing grid 70 while restricting flow of relatively larger sized aggregate material. The sizing grid 70 can also have structural supports (not shown), such as steel I-beams, that can support an aggregate material mover, such as a bobcat, a front end loader, and the like. In this way, the aggregate material mover can drive over the sizing grid 70 to crush and break up larger sized aggregate material or agglomerations of aggregate material.

The conveyor system 80 can be disposed under the hopper 30. Specifically, the conveyor system 80 can be disposed under the material containment space 40 of the hopper 30. The conveyor system 80 can include a plurality of conveyor belts, indicated generally at 90, that can move aggregate material from the material containment space 40 and away from the unloading station 10 to a remote location or dump site.

In one aspect, the conveyor belts 90 can include a longitudinal conveyor belt 92 disposed between the front and rear retaining walls 32 and 34. The longitudinal conveyor belt 92 can be oriented in a substantial horizontal orientation or in an orientation substantially parallel to the ground surface 8. The longitudinal conveyor belt 92 can extend substantially the longitudinal length L1 of the hopper 30. Additionally, the conveyor system 90 can include a transverse or lateral conveyor belt 94. The lateral conveyor belt 94 can have a receiving end 96 disposed under a discharge end 98 of the longitudinal conveyor belt 92. The lateral conveyor belt 94 can extend from the receiving end 96 away from the hopper 30 to a remote location.

Together the hopper 30 and the conveyor system 80 can form an integrated structure that can be transported as a single unit that is configured for quick installation adjacent an existing transport vehicle thoroughfare 8.

The unloading station 10 can also include a vibrator 100 that can vibrate the hopper 30 to shake loose aggregate material that may become stuck to and/or in the hopper 30. Additionally, the unloading station 10 can include a transport vehicle vibrator 110 that can vibrate the dump bed 14 of the transport vehicle 12 to shake loose aggregate material stuck in the dump bed 14. Such vibrators are further described in the inventors co-pending U.S. patent application Ser. No. 11/811,737, filed on Jun. 11, 2007, which is herein incorporated by reference in its entirety for all purposes.

The vibrator 110 can be pivotally coupled to the rear wall 34 of the hopper 30. A pair of structural beams 112 can extend upward along a central location of the rear wall 34 to an elevation above the rear wall. An arm 114 can be pivotally coupled to the structural beams 112 and can pivot between a retracted position and an engaged position. In the retracted position the vibrator 110 does not contact the transport vehicle 12. In the engaged position, the vibrator 110 can contact the dump bed 14 of the transport vehicle 12 when the dump bed 14 is in the tilted or dumping position, as shown in FIG. 3. The arm can be pivoted between the engaged and retracted positions by an actuator such as hydraulic cylinders, electric motors, or the like.

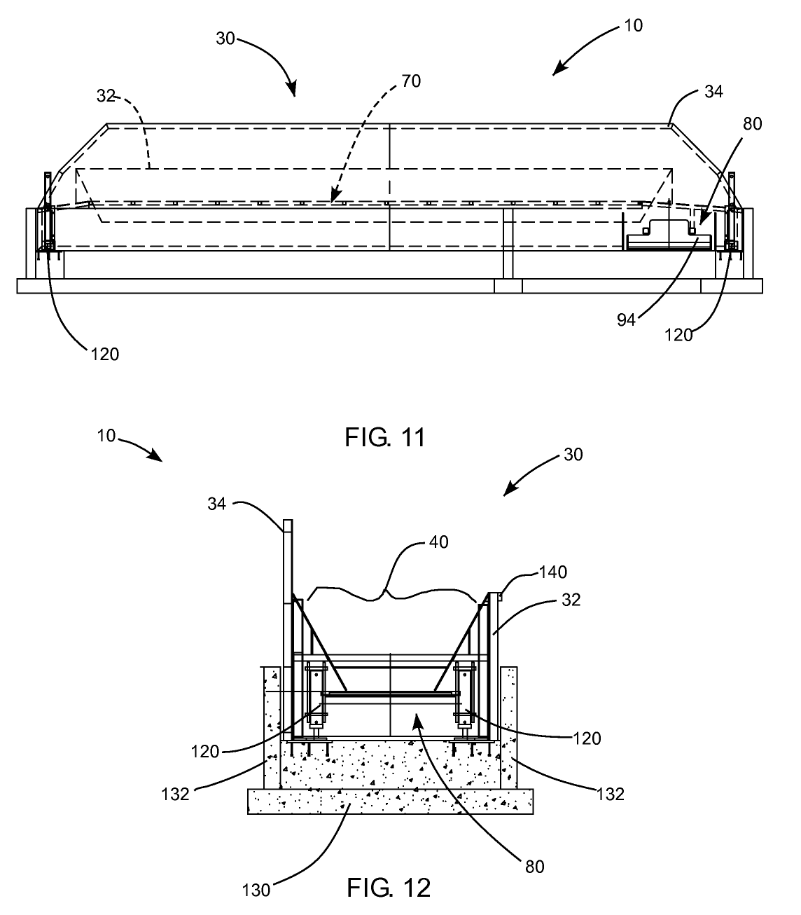

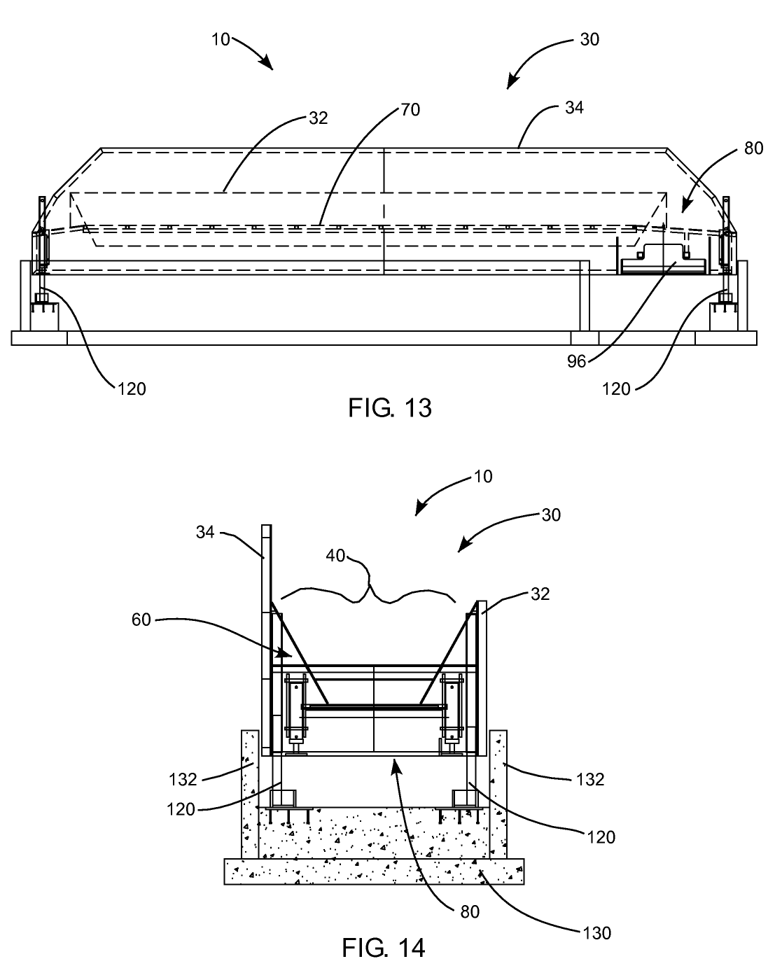

The unloading station 10 can also include a plurality of extendable jacks 120 that can raise the unloading station for cleaning and servicing. The plurality of jacks 120 can be positioned adjacent to the containment walls 32 and 34. The plurality of jacks 120 can raise the unloading station 10 to allow access under the hopper 30 and the material transfer space 40. For example, the jacks can be hydraulic cylinders that can lift the integrated structure of the conveyer system 80 and hopper 30. In one aspect, the plurality of jacks 120 can raise the unloading station 10 up to a height greater than approximately 24 inches. Thus, the unloading station 10 can be operated in an un-raised position, as shown in FIGS. 11-12, or serviced and cleaned in a raised position, as shown in FIGS. 13-14. Safety stands (not shown) can be locked into position under the raised unloading station to reduce the likelihood of the station falling from the raised position inadvertently.

The unloading station 10 can also include a bumper 140 (FIGS. 2-3) attached to the front wall 32. The bumper 140 can reduce damage caused by contact between the transport vehicle 12 and the front wall 32. The bumper 140 can also alert the driver of the transport vehicle 12 when the transport vehicle is in proper position for dumping. The bumper 140 can be formed of a plastic or rubber material, as known in the art.

The present invention also provides for a method for unloading a side-dump aggregate material transport vehicle including positioning a side-dump aggregate material transport vehicle on a thoroughfare adjacent a side-dump unloading station. A dump bed of the aggregate material transport vehicle can be tipped along a longitudinal axis of the vehicle in order to dump aggregate material contents of the dump bed along a side of the transport vehicle and into a hopper of the unloading station. A conveyor system disposed under the hopper of the unloading station can be activated to convey aggregate material away from the hopper of the unloading station.

The step of activating the conveyor system can also include activating a longitudinal conveyor belt disposed below the hopper and extending substantially a length of the hopper to move aggregate material from the length of the hopper to a discharge end of the longitudinal conveyor belt. Additionally, a lateral conveyor belt disposed under the discharge end of the longitudinal conveyor belt can be activated to receive and convey aggregate material away from the unloading station.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An aggregate material unloading station configured to rapidly receive and transfer the contents of a side-dump aggregate material transport vehicle, the unloading station comprising:
a) a hopper disposed at least partially below a ground level and extending longitudinally adjacent an aggregate material transport vehicle thoroughfare, the hopper further comprising:
i) a front retaining wall disposed adjacent the transport vehicle thoroughfare with an elevation configured to allow aggregate material to pass from a dump bed of the transport vehicle into the hopper when the dump bed is in a dump position;
ii) a rear retaining wall disposed in a spaced apart relation to the front retaining wall with an elevation configured to substantially impede movement of aggregate material dumped from the transport vehicle; and
iii) a material containment space disposed between the front retaining wall and the rear retaining wall, sized and shaped to substantially contain aggregate material dumped from the transport vehicle; and
b) a conveyor system disposed under the material containment space, and operable to receive and move aggregate material from the material containment space.

2. A station in accordance with claim 1, wherein the hopper and the conveyor system together form an integrated structure transportable as a single unit, and configured for quick installation adjacent an existing transport vehicle thoroughfare.

3. A station in accordance with claim 1, wherein the front retaining wall is shorter in height than the rear retaining wall.

4. A station in accordance with claim 3, wherein the front retaining wall is approximately 36 inches high and the rear retaining wall is approximately 72 inches high in relation to a ground level.

5. A station in accordance with claim 1, wherein the hopper further includes:
a) a material flow regulator disposed at least partially below the material containment space, and configured to direct and regulate the flow of aggregate material moving from the material containment space to the conveyor system.

6. A station in accordance with claim 5, wherein the material flow regulator includes a plurality of baffles sized and shaped to direct and regulate flow of aggregate material and to limit loading on the conveyor system.

7. A station in accordance with claim 5, wherein the material flow regulator further includes a sizing grid extending across the hopper, the sizing grid including apertures having a predetermined size in order to restrict flow of aggregate material larger than the predetermined size.

8. A station in accordance with claim 1, the conveyor system further comprising:
a) a longitudinal conveyor belt disposed between the front and rear retaining walls and extending along a longitudinal length of the hopper; and
b) a transverse conveyor belt disposed under a discharge end of the longitudinal conveyor belt and extending away from the hopper.

9. A station in accordance with claim 1, further comprising a vibrator to vibrate the hopper to shake loose aggregate material stuck to the hopper.

10. A station in accordance with claim 1, further comprising a vibrator to vibrate a dump bed of the transport vehicle to shake loose aggregate material stuck in the dump bed.

11. A station in accordance with claim 1, wherein the hopper further includes a plurality of lifting jacks adjacent the containment walls, the plurality of jacks being configured to raise the unloading station to allow access to the hopper and the material transfer space.

12. A station in accordance with claim 11, wherein the plurality of jacks raise the unloading station up to a height greater than approximately 24 inches in relation to a footing disposed below the unloading station.

13. A station in accordance with claim 1, wherein the transport vehicle is a side-dump semi-truck trailer, and the transport vehicle thoroughfare is a roadway.

14. A aggregate material unloading station for receiving and transferring the contents of a side-dump aggregate material transport vehicle, the unloading station comprising:
a) a hopper extending longitudinally alongside an aggregate material transport vehicle thoroughfare, the hopper having a front wall sized to receive aggregate material from a side-dump transport vehicle, and a rear wall sized to impede the flow of the aggregate material dumped over the front wall by the side-dump transport vehicle; and
b) a conveyor system disposed under the hopper, and operable to move aggregate material from the hopper to a remote location away from the unloading station.

15. A station in accordance with claim 14, wherein the hopper and the conveyor system together form an integrated structure transportable as a single unit, and configured for quick installation adjacent an existing transport vehicle thoroughfare.

16. A station in accordance with claim 15, wherein the integrated structure of the unloading station is disposable in a relatively shallow excavation of less than approximately 48 inches deep.

17. A station in accordance with claim 1, wherein the hopper is disposed at least partially below a ground level, and further includes:
a) a material containment space disposed between the front wall and the rear wall, sized and shaped to substantially contain aggregate material dumped from the transport vehicle; and
b) a material flow regulator disposed at least partially below the material containment space, and configured to direct and regulate the flow of aggregate material moving from the material containment space to the conveyor system.

18. A method for unloading a side-dump aggregate material transport vehicle, comprising:
a) positioning a side-dump aggregate material transport vehicle on a thoroughfare adjacent a side-dump unloading station;
b) tipping a side-dump bed of the aggregate material transport vehicle along a longitudinal axis of the vehicle to dump aggregate material along a side of the transport vehicle and into a hopper of the side-dump unloading station;
c) allowing the aggregate material to gravity feed downward through a material flow regulator of the hopper; and
c) activating a conveyor system disposed under the hopper of the side-dump unloading station to convey aggregate material away from the unloading station.

19. The method of claim 18, wherein the step of activating the conveyor system further includes:
a) activating a longitudinal conveyor belt disposed below the hopper and extending substantially a length of the hopper to move aggregate material from the length of the hopper to a discharge end of the longitudinal conveyor belt; and
b) activating a lateral conveyor belt disposed under the discharge end of the longitudinal conveyor belt to receive and convey aggregate material away from the unloading station.

20. The method of claim 15, wherein the hopper further comprises:
a) a front retaining wall extending longitudinally alongside the transport vehicle thoroughfare;
b) a rear retaining wall disposed in a spaced apart relation to the front retaining wall and having a higher elevation than the front retaining wall; and
c) a material containment space disposed between the front and rear retaining walls, and configured to substantially contain aggregate material dumped from the side-dump transport vehicle.
